(19) United States
(12) Patent Application Publication
(10) Pub. No.: US 2013/0142012 A1
(43) Pub. Date: Jun. 6, 2013

(54) ADAPTIVE COMPACT TOWED ARRAY SHAPE-SENSING AND CONTROL MODULE

(71) Applicants: Jeffrey Patrick Schultz, Blacksburg, VA (US); Robert Flelder, Blacksburg, VA (US)

(72) Inventors: Jeffrey Patrick Schultz, Blacksburg, VA (US); Robert Flelder, Blacksburg, VA (US)

(21) Appl. No.: 13/470,001

(22) Filed: May 11, 2012

Related U.S. Application Data
(60) Provisional application No. 61/484,723, filed on May 11, 2011.

(51) Int. Cl. G01S 15/06

(52) U.S. Cl. CPC G01S 15/06
USPC 367/106

(57) ABSTRACT

The present invention relates to towed array shape sensing and manipulation. More particularly, embodiments of the present invention relate to an array of multiple flow sensors positioned at set lengths along a tow cable to measure changes in the flow direction and water speed as a function of position along the length of the cable, which can be used to accurately determine tow cable shape and assist in maintaining a desired tow cable shape. Embodiments include a system for determining the shape of a towed cable comprising: a tow cable; multiple probes linearly distributed along the cable, each for measuring pressure, velocity, and/or flow direction in water; and means for using the measurements as a function of probe position along the cable to determine cable shape or to correct/restore cable shape during use with the aid of actuators and a control system.

### CROSS-REFERENCE TO RELATED APPLICATIONS

This application claims priority to and the benefit of the filing date of U.S. Provisional Application No. 61/484,723, filed on May 11, 2011, the disclosure of which is hereby incorporated by reference herein in its entirety.

### BACKGROUND OF THE INVENTION

1. Field of the Invention

The present invention relates to towed array shape sensing and control. More particularly, embodiments of the present invention relate to an array of multiple flow sensors positioned at set lengths along a tow cable. Each flow senor measures and reports the relative velocity and direction of water flow with respect to the sensor as a function of time. Multiple flow sensors positioned along the length of the cable can be used to accurately determine tow cable shape and assist in maintaining a desired tow cable shape.

2. Description of Related Art

Each of the hydrophones in a submarine's towed sonar array detects sound sources. However, the major advantage afforded by the array configuration is the signal processing techniques of beamforming and interferometry which can be used to calculate the distance and the direction of a sound source. For accurate calculation of the source location, the relative positions of the hydrophones need to be known and this can only be guaranteed without external information when the cable is straight. For surface ships, GPS can be used to monitor the shape of the array. For submerged submarines, GPS is not available, and as such the towed sonar array is rendered ineffective during maneuvers that cause the array's extremely long cable (thousands of feet) to become curved. Loss of the towed sonar array data renders the submarine vulnerable to attack and/or potentially results in the loss of the location of its target. A schematic illustration of a submarine with a tow cable is provided in FIG. 1.

Navy combat and surveillance operations are increasingly conducted in the shallow littoral zones, which places increased restrictions on depth and maneuverability. Submarine operations are thus highly constrained. Towed sonar arrays are a primary sensing platform for submarines and their functionality is significantly compromised in these conditions. Towed arrays are passive, directional and require that the array be: (1) linear in order to resolve target bearings, and (2) must be in-line, or at least parallel to the towing ship in order to resolve accurate relative bearings. During maneuvers, or while operating with relatively large cross currents, the array is out of alignment and therefore not useable. Depth is another major issue. Deployed arrays are pulled deeper by the tow cable and they are at risk of dragging which causes damage as well as overwhelming noise interference. Additionally, if an array is too close to the surface, then wave action affects its linearity.

Current towed array control systems are completely passive, based on a drogue system, and require some minimal tow speed in order to apply tension to the trailing end of the array. This method is ineffective at very low speeds. Furthermore, passive systems cannot correct for cross-currents. The current method to control depth is to regulate the tow cable length. Shortening the deployment distance to decrease depth, however, results in additional interference from the ship's noise and turbulence. Finally, while there are several technologies being developed to monitor the shape and position of the array, such as fiber optic, accelerometer-based, gyroscope based, etc., none of these techniques provides direct information on the local flow conditions around the array, which would thus enable active control of the array shape and position.

Thus, there is a critical need to develop a towed array control module that can be used on arrays, whether towed by submarines, surface ships, helicopters, or anchored to buoys. Such an array would ideally monitor or control the array shape and position relative to the deployment platform, as well as the depth of the array.

### SUMMARY OF THE INVENTION

The present invention provides multi-port flow sensors for effectively determining the shape of the tow cable, thus allowing for accurate performance of the towed array when the tow cable is not straight (during maneuvers for example). Flow sensors disposed at various intervals along the length of a tow cable can be used to collect information (such as the relative flow speed and flow direction as a function of position along the cable) for determining the overall shape of the towed cable and/or for use in controlling the shape of the cable. Data from the flow sensors on the tow cable may also be used in conjunction with data from a traditional multi-hole probe mounted to the tow vessel. A schematic illustration of a representative sensor disposed on a tow cable is shown in FIG. 2.

Objects of the present invention provide methods of measuring towed array cable shape, as well as systems employing such methods, comprising: obtaining flow measurements from sensors distributed along a tow cable; determining towed array shape from the measurements.

Such methods and systems can comprise sensors having an annular array of pressure sensors disposed circumferentially around the tow cable.

In embodiments, the methods and systems can employ a method of correcting towed array shape comprising: obtaining flow measurements from sensors attached to a towing platform; determining towed array shape from the measurements.

Further embodiments may comprise methods of controlling towed array shape, position, depth or orientation; further comprising actuating one or more actuators disposed on a towed array, in which the actuators are operably configured for controlling control surfaces. Such methods can utilize an automated control system which may employ artificial intelligence learning algorithms such as neural networks.

Additional embodiments pertain to methods of measuring velocity, flow direction, angle of attack or angle of sideslip in a single probe using flow measurements in water. Methods and systems of the invention can comprise additional sensors in the probe for measuring vertical orientation and/or depth, its orientation with respect to the gravity vector, and its heading. Additional sensors, such as accelerometers and gyroscopes, may be also be used in the system.

Systems of embodiments of the invention for determining shape of a towed cable can comprise: a tow cable; multiple probes linearly distributed along the cable, each for measuring one or more of pressure, velocity, and/or flow direction; and means for using the measurements as a function of probe position along the cable to determine cable shape.

Objects of embodiments of the invention further provide a system for controlling array shape, position, depth, or orientation comprising: one or more actuators for controlling control surfaces with means for connecting the actuators to a towed array; and a control module in operable communication with the actuators for providing instructions to and for controlling the actuators in a manner to modify the towed array shape, position, depth, or orientation. Such systems can further comprise an automated control system which may employ learning using neural network algorithms.

### BRIEF DESCRIPTION OF THE DRAWINGS

The accompanying drawings illustrate certain aspects of some embodiments of the present invention, and should not be used to limit or define the invention. Together with the written description the drawings serve to explain certain principles of the invention.

FIG. 1 is a schematic illustration of a submarine with a curved tow cable.

FIG. 2 is a schematic illustration of a representative multi-port probe (flow sensor) comprising one or more pressure sensors disposed around a tow cable for determining the local flow conditions along the length of the cable during use.

FIG. 3 is a schematic illustration of an exemplary hemispherical type multi-port probe comprising multiple sensors, which can be used to determine local speed and direction of the flow at points along the tow cable or the tow vessel.

FIG. 4 is a schematic illustration of an exemplary radial type multi-port flow sensor (probe) also suitable for towed array shape sensing.

FIG. 5 is a schematic illustration of an exemplary actuator that can be used to correct the shape of a tow cable, which is shown in the stowed configuration to minimize flow noise during normal operation.

FIG. 6 is a schematic illustration depicting the actuator shown in FIG. 5, which is temporarily deployed to increase drag after a maneuver.

FIG. 7 is a schematic diagram illustrating how multiple flow sensors can be used to detect angular change and thus curvature along the length of a towed array.

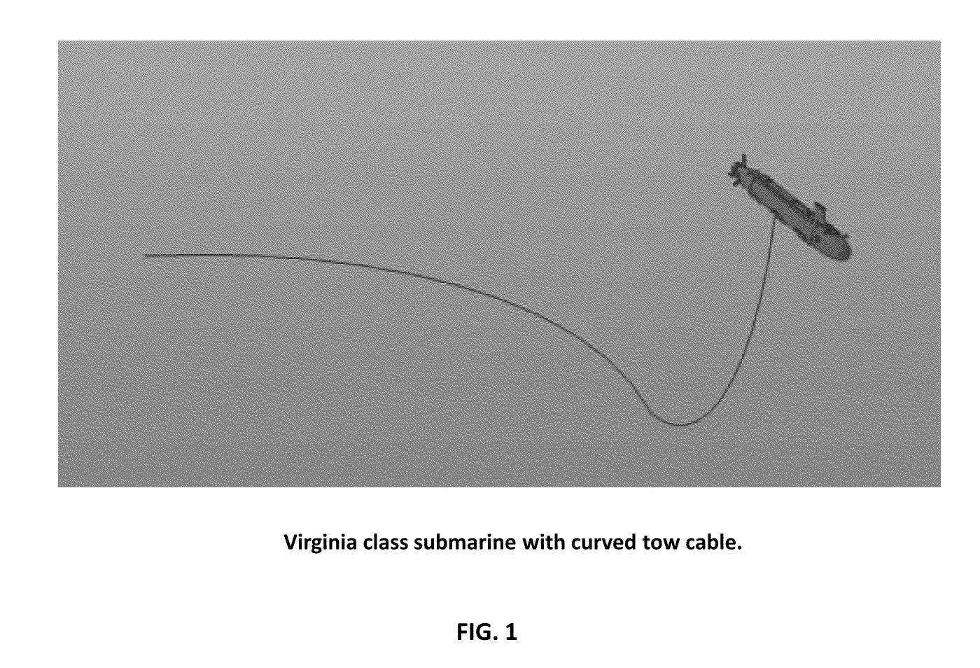

### DETAILED DESCRIPTION OF VARIOUS EMBODIMENTS OF THE INVENTION

Reference will now be made in detail to various exemplary embodiments of the invention. It is to be understood that the following discussion of exemplary embodiments is not intended as a limitation on the invention. Rather, the following discussion is provided to give the reader a more detailed understanding of certain aspects and features of the invention.

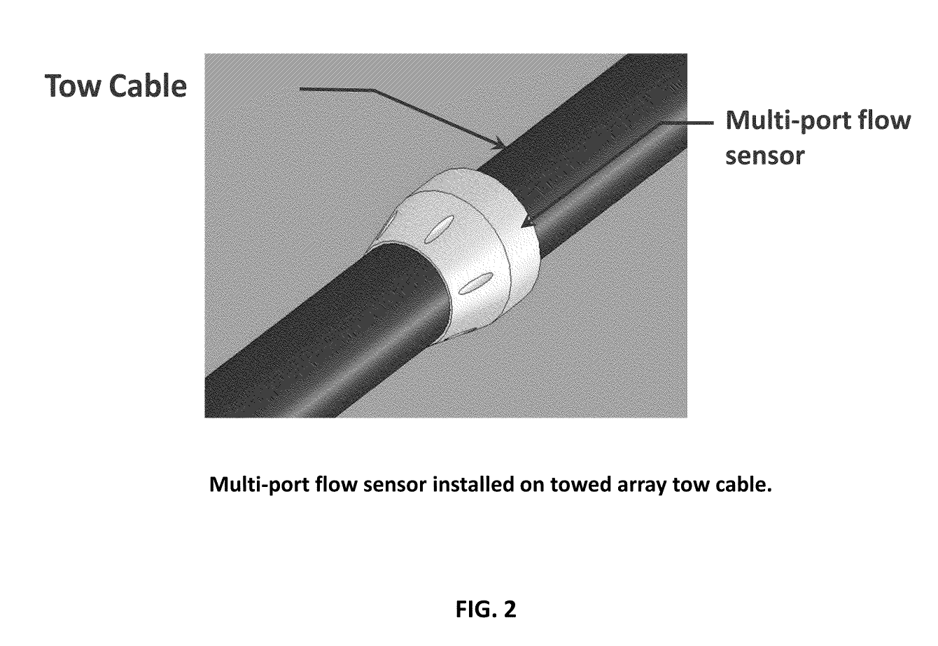

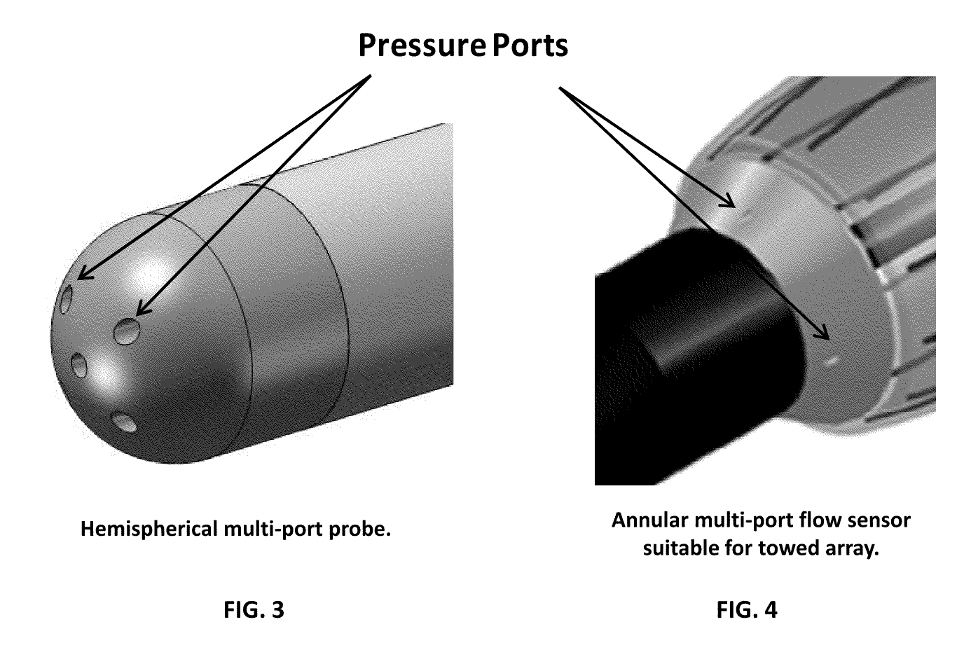

Flow speed, flow direction, position, orientation and shape sensing. Flow speed and direction sensing can be accomplished using pressure sensors mounted in a probe disposed on a tow cable. In preferred embodiments, there may be a radial array of pressure sensors, typically mounted within an annular probe (flow sensor) which surrounds the tow cable circumference as shown in FIG. 2. The probe shown in FIG. 3 is a typical example of a water-based probe for measuring fluid flow in water, which could be mounted to the tow vessel. The number and location of the sensors disposed in the probe is not critical and may be modified for particular applications. For example, it may be desired to have from 1-20 pressure ports, such as from 2-15, or from 3-12, or from 4-10, or from 5-8, and so forth.

In embodiments, it may be preferred to have for example about 10 or fewer pressure ports disposed substantially circumferentially around the probe head, with for example 1-3 pressure ports disposed internally to them. It may also be desired to have the pressure ports disposed in two or more circumferential rows around the probe. For example, a first centrally located row could comprise from 3-5 pressure ports, with a concentric row of ports disposed outwardly from the first row and having from 2-13 pressure ports in the second row. Even further, a third row of ports could be disposed outwardly from the second row and can comprise from 3-18 ports. The annular type probe (flow sensor) is attached to the circumference of the tow cable. The hemispherical type probe can be used with a towed array system and attached to the side of the tow cable , can be disposed at the distal end of the tow cable relative to the vehicle towing the cable, or attached to the tow vessel. The terms “circumferential,” “radial,” and “concentric” in the context of this specification are intended to refer generally to the pressure ports being disposed around the surface of the probe head and it is not critical that there be distinct rows of pressure ports or that the ports be disposed exactly circumferentially, radially, or concentric relative to one another or the probe head.

The probe(s) comprising the pressure ports can be disposed at any location on the tow cable. For longer tow cables, more probes may be desired. In preferred embodiments, at least 3-50 probes comprising at least 1-8 pressure ports each are disposed at a desired distance from one another along the length of the tow.

In embodiments, if the probe is aligned with the flow, the angles of attack and side slip are zero and the pressure at each port is identical. As relative flow deviates off-angle, a differential pressure across the sensor(s) exists and, using fluid mechanics, the angle of the probe relative to the flow can be accurately measured. The flow data collected from each probe can then be compiled and interpreted to determine the orientation of each sensor with respect to the flow and thus the overall shape of the cable in tow. Typically, it can be expected that as the number of sensors increases in the overall system, higher position accuracy can be obtained.

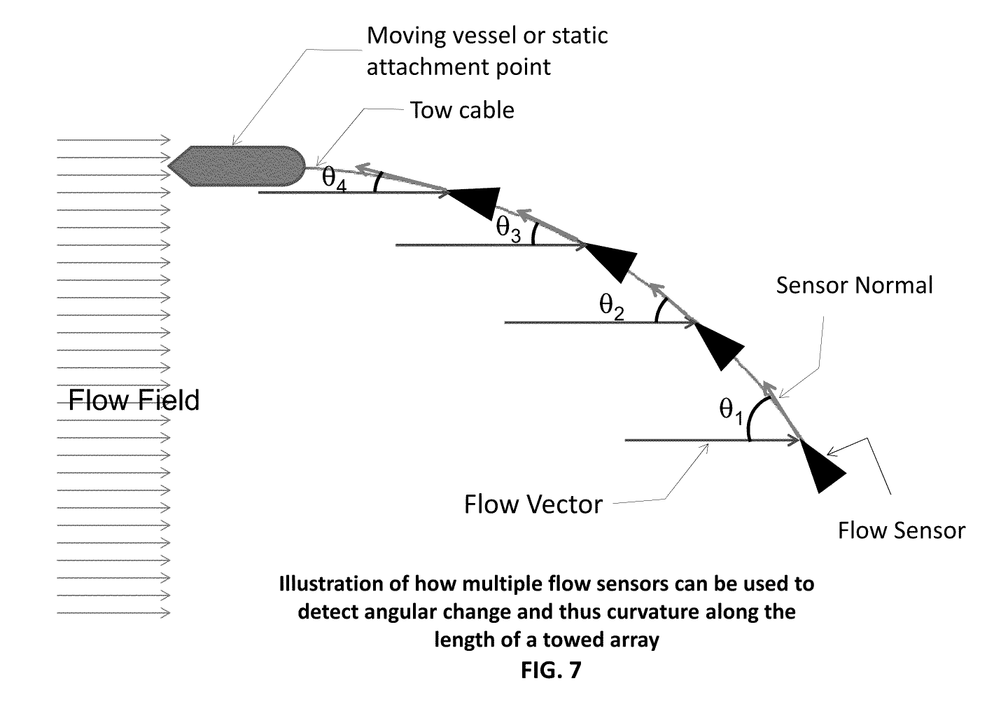

The shape of the towed array cable can be determined using multiple multi-port flow sensors positioned along the length of the cable as follows. A cable with certain shape is in flow with a certain magnitude and direction. This magnitude and direction is assumed to be constant over the region in which the cable lies. Thus all of the flow sensors will measure the same flow vector (flow speed and direction) but the orientation of that vector with respect to the sensor normal will depend on the curvature of the tow cable. FIG. 7 shows a schematic where the angle θ changes as a function of length due to the curvature of the tow cable. Furthermore, the greater the number of flow sensors the more accurately the local curvature of the cable can be obtained. In flows where the magnitude and direction are not constant in the region of the tow cable, more complex algorithms can be used to determine the angles and thus shape. A flow sensor (a hemispherical multi-port probe for example) mounted to the tow vessel can also be used to provide knowledge of the flow field and flow field changes upstream of the tow cable. Additionally depth sensors can be used to determine/augment the vertical component of the curvature of the cable.

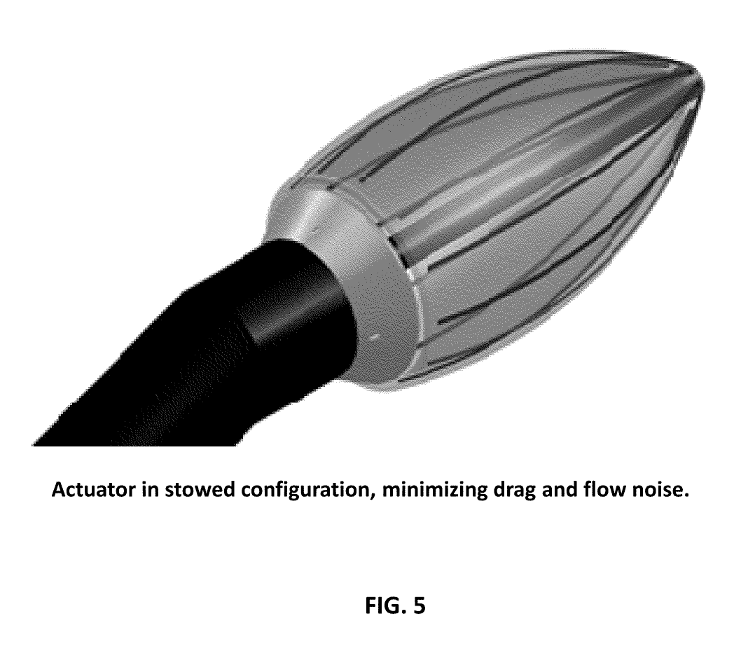

In a probe configuration designed for a towed array, the pressure ports can be positioned radially about the tow cable, thus minimizing protrusion. An exemplary towed-array specific probe is shown in FIG. 2 and FIG. 4. This type of probe is preferred for its low-profile configuration and orientation of the pressure ports, which can be disposed circumferentially around the outer surface of the towed array cable. Thus, the misalignment angle between the tow cable and fluid flow would be measured. The flow vector misalignment angle can be measured at multiple locations along the cable and the overall shape of the towed array determined. Optionally, control surfaces can be deployed to maximize use of existing flow to straighten the array. These control surfaces could comprise the drogue system in FIG. 4 and FIG. 5 or they could comprise flaps or rudders that can steer and or straighten the towed array.

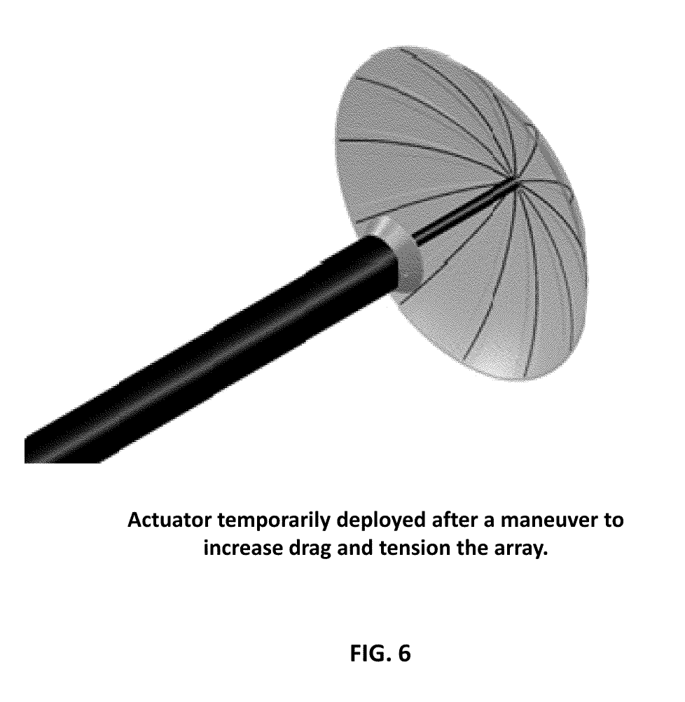

Additional embodiments of the invention combine a novel towed array shape sensing technology with an actuator to enable monitoring and control of towed array shape, depth and orientation. Control signals can be provided to the actuator to reposition the array as necessary. Shape sensing can be accomplished using multi-port type flow sensors, which provide unique flow characteristic data as a function of position along the cable. Coupled with an actuator control module, this hydrodynamic instrumentation technology could be used to efficiently utilize flow energy, analogous to a sail, to position the array in complex flow environments. For example, if the tow cable and array need to be straightened or the depth changed, the drogue system shown in FIG. 5 and FIG. 6 could be actuated to provide greater drag and effectively increase the tension on the tow cable and straighten it. Once the cable is straight or in position, the drogue system could be closed to reduce drag. In low flow environments the drogue could be pulsed open and closed to propel the tow cable away from its attachment point to straighten the array.

Smart material actuators. Representative actuators for this system could be based on any actuation technology including smart materials, hydraulics, pneumatics, electric motors, etc. FIG. 5 is a schematic illustration of an exemplary actuator (drogue-type) that can be used in the method and system embodiments of the invention. The actuator is shown in the stowed configuration to minimize flow noise during normal operation. FIG. 6 shows the actuator temporarily deployed to increase drag.

In embodiments, one or more actuators can be attached to the tow cable at one or more desired positions along the length of the tow cable. Means for attaching the actuators can comprise quick-release securing means, such as a releasable clip, or can comprise fusing or bonding of the actuator to the tow cable using an adhesive. The actuators are preferably attached using means that can allow for detaching of the actuators with little to no effort. Coupling shape measurement with actuation can be used to enable steering and repositioning of the towed array to a desired shape or position.

Systems of the invention can be used to adaptively configure control surfaces at each end of the array, or at any point along the length of the array, to position the array under a variety of adverse flow and surface action conditions, when coupled with additional towed array position, shape and vertical orientation sensors.

Position/orientation and actuator control technologies. There are several sensors that either are or can be developed to monitor the shape, position, depth and orientation of a towed array including fiber optic shape sensing, digital compasses (flux gate magnetometers), accelerometer-based inertial navigation and vertical orientation, strain sensors (measure bend radius), pressure sensors, etc. Pressure sensors may include Entran EPB-S591A or Endevco 8507C. These methods could potentially be used in conjunction with an actuator technology, distributed along the array, to straighten the array.

After measuring the flow characteristics along the tow cable and subsequently calculating the curvature, control surfaces can be deployed to straighten or reposition the array given the current flow conditions. These are functionalities that can be incorporated into the system embodiments of the invention.

Neural network control algorithms for adaptive closed-loop control. Neural network technology is a powerful tool that could potentially be used to provide adaptive, closed-loop actuator control. The basic nature of a neural network is the ability to learn from experience. Architectures such as the Feed Forward, Backward Propagation algorithm (FFBP) utilize inputs from multiple sensing parameters and then generate output signals with the goal of realizing a desired outcome. The actual outcome is measured and the results fed back into the neural network such that the next attempt is improved. This cycle continues throughout the training phase of the algorithm and, indeed, can extend through the life of the system.

Applied to towed array control, such a system could be trained in a relatively controlled environment to achieve acceptable performance and then deployed in the field. Once deployed, additional training information could be obtained from one or more towed array systems as each experiences different environmental and operational scenarios. These data could then be combined to collectively improve the entire fleet of arrays.

The algorithm could be trained/calibrated by deploying the towed array in known flow scenarios with enhanced positional information from external sensors so the algorithm learns the operations and maneuvers that yield the desired positional output from external sensors.

The present invention has been described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design. Other embodiments of the invention will be apparent to those skilled in the art from consideration of the specification and practice of the invention. Where a range of values is provided in this specification, each value between the upper and lower limits of that range is also specifically disclosed. The upper and lower limits of these smaller ranges may independently be included or excluded in the range as well. As used in this specification, the singular forms “a,” “an,” and “the” include plural referents unless the context clearly dictates otherwise. It is intended that the specification and examples be considered as exemplary in nature and that variations that do not depart from the essence of the invention are intended to be within the scope of the invention. Further, the references cited in this disclosure provide general background about the technology or components that can be incorporated into systems and methods of the invention, each being relied on for purposes of providing a detailed disclosure of the invention and each incorporated by reference herein in its entirety.

1. A method of measuring towed array shape comprising:
obtaining flow measurements from sensors linearly distributed along a tow cable;
determining towed array shape from the measurements.

2. The method of claim 1, wherein the sensors comprise an annular array of pressure sensors disposed circumferentially around the tow cable.

3. A method of correcting towed array shape comprising:
obtaining flow measurements from sensors attached to a towing platform;
determining towed array shape from the measurements.

4. A method of controlling towed array shape, position, depth or orientation comprising actuating one or more actuators disposed on a towed array, which actuators is operably configured for controlling control surfaces.

5. The method of claim 4 comprising automated control system learning using neural network algorithms.

6. A method of measuring velocity, angle of attack or angle of sideslip in a single probe using flow measurements in water.

7. The method of claim 6 comprising additional sensors in the probe for measuring at least one of vertical orientation, depth or heading.

8. The method of claim 6 further comprising at least one additional sensor chosen from accelerometers and gyroscopes.

9. A system for determining shape of a towed cable comprising:
a tow cable;
multiple probes linearly distributed along the cable, each for measuring one or more of pressure, velocity, or flow angle using flow measurements sensors in water; and
means for using the measurements as a function of probe position along the cable to determine cable shape.

10. A system for controlling array shape, position, depth, or orientation comprising:
one or more actuators for controlling control surfaces with means for connecting the actuators to a towed array; and
a control module in operable communication with the actuators for providing instructions to and for controlling the actuators in a manner to modify the towed array shape, position, depth, or orientation.

11. The system of claim 9 further comprising automated control system learning using neural network algorithms.
